(19) United States
(12) Patent Application Publication
(10) Pub. No.: US 2006/0200436 A1
(43) Pub. Date: Sep. 7, 2006

(54) Gene expression programming with enhanced preservation of attributes contributing to fitness

(76) Inventors: Chi Zhou, Schaumburg, IL (US); Weimin Xiao, Hoffman Estates, IL (US)

Correspondence Address: MOTOROLA, INC., 1303 EAST ALGONQUIN ROAD, IL01/3RD, SCHAUMBURG, IL, 60196, US

(21) Appl. No.: 11/073,828

(22) Filed: Mar. 7, 2005

(51) Int. Cl. G06N 3/12

(52) U.S. Cl. 706/13

(57) ABSTRACT

A Gene Expression Programming method evolves a population of chromosomes which are arrays of integer index references to genes including operand and operator genes. The mathematical expressions are encoded in the chromosomes according to linear Polish notation, according to which expression, trees representing mathematical expression encoded in the chromosomes are developed in a depth-first manner from the sequence of genes in each chromosome. This type of Polish notation makes it more likely that sub-expressions that contribute to fitness will survive evolutionary operations which can be performed at a low computational cost on array chromosomes. Additionally subexpressions or the mathematical structure of subexpressions which are assumed to contribute significantly to fitness based on the frequency of their appearance in elite members are protected from alteration by evolutionary operations, by representing each such mathematical structure by a single derived gene while the evolutionary operations are performed.

### FIELD OF THE INVENTION

The present invention relates in general to genetic algorithms. More particularly, the present invention relates to genetic programming.

### BACKGROUND OF THE INVENTION

Algorithms for fitting experimental data to linear equations or to other predetermined functions of one or more variables are widely used in applied science and engineering. In fitting data to a predetermined function, parameters (e.g., coefficients) of the predetermined function, which are a priori unknown, are determined. These parameters, which may represent theoretical constants (e.g., the mass of an electron), or merely empirical values that characterize a phenomenon, are determined in fitting data to the function. In such situations, the appropriate function to fit to the data is selected by a person based on technical knowledge or preexisting evidence. For example, certain types of data may be known by experts in the relevant field to be described by certain mathematical functions. The discovery of what mathematical functions describe what type of data comes through the painstaking progress of science and engineering.

Similarly, in the field of statistics, statistical data may be fit to an appropriate distribution function such as the Gaussian Distribution, or the Binomial Distribution, in order to determine a mean and variance of measured data. The selection of an appropriate distribution function to fit to any given set of data is based on consideration of whether the type of random variation associated with each type of distribution corresponds to the random variations that is expected to characterize the collected data. In other words, selection is ordinarily the work of a skilled statistician.

Certain statistical software packages attempt to assist the statistician by automatically trying to fit a set of data to a predetermined set of distribution functions, and selecting the distribution function which best fits the data.

In the cases mentioned above the functions to which data are fit are predetermined, and it remains a task of the scientist or engineer to discover through conjecture or ab initio derivation entirely new functions that may apply to new types of data. In other words, the work of discovering mathematical functions that apply in science, engineering and other fields is left to human intellect.

The field of artificial intelligence includes the sub-field of genetic algorithms. In the field of genetic algorithms, an attempt is made to mimic the role of genetics in evolutionary biology, in computing the solution of engineering or other problems. In genetic algorithms, a population of representations of possible solutions is randomly generated and ‘evolved’ in a way that mimics Darwinian theories of evolution.

The field of genetic algorithms includes an area of study known as genetic programming. In genetic programming the population being evolved includes individuals that are themselves programs. In genetic programming the fitness of each individual program is judged based on its ability to solve a certain problem when it is executed.

Genetic programming has been used to perform what is known as ‘symbolic regression’. In symbolic regression, an effort is made to supplant human intellect by using genetic programming to discover a mathematical expression that best describes a data set. The individual programs that are evolved in genetic programming based symbolic regression represent mathematical equations that give the value of a dependent variable based on the input values of one or more independent variables. Genetic programming has also been used for classification. A program that encodes a mathematical function can be used for classification if the independent variables of the mathematical function are made to correspond to a set of quantified attributes derived from objects to be classified, and one or more predetermined ranges of the value of the mathematical function are associated with positive identifications of a one or more classes.

Predominant prior art genetic programming algorithms were implemented in the LISP programming language which was judged by the implementers to be especially suited to the task. In such algorithms, the S-expression construct of the LISP programming language was used to represent mathematical expressions. These S-expressions, which played the role of members of a population being evolved, were directly manipulated in the course of performing the evolution. A drawback of such prior art approaches is that the size of the mathematical expressions in the population was not limited, which lead to so called ‘expression bloating’ in which the mathematical expressions in the population become unduly large. Another drawback of such prior art approaches is that such bloated expressions tend to over fit the data that the genetic programming algorithm is using to check the correctness of mathematical expressions. By over fit it is meant that the expression conforms very closely to the data including measurement errors in the data, but does not conform to additional data from the same source that is later used to test the correctness of the expression. A further drawback is that such S-expression constructs are not available in modern program languages such as Java, or C++ which are currently preferred for use in the scientific and engineering programming.

A recently developed form of Genetic Programming is called Gene Expression Programming (GEP). In GEP mathematical expressions are represented by a list of tokens which include operators (e.g. +, −, /, *) and operands. The operands include constants (e.g., 1, 2, Pi, e) and one or more independent variables (e.g., X, t). In the context of GEP the tokens are called genes and the list is called a chromosome. Co-pending patent application Ser. No. 10/101,814 filed Mar. 18, 2002, assigned in common with the present invention, addresses certain improvements of GEP. In GEP a variety of ‘evolutionary operations’ that mimic the natural processes involved in the evolution of a population are performed. These include exchange of portions of the lists of tokens between population members, rearrangement of tokens in individual population members and mutation in which a token is changed to a different token. These processes involve random selection of crossover points for exchanges and for mutation random selection of new tokens to replace other tokens (operands or operators). Due to their random nature these operations, which are important in adaptation through evolution, may, unfortunately, in the case of gene expression programming, lead to syntactically incorrect expressions (programs). Such syntactically incorrect are unsuitable as solution candidates, and have the potential to generate a program execution error in the gene expression programming algorithm. Co-pending patent application Ser. No. 10/101,814 referenced above discloses a method for validating chromosomes. Nonetheless, it has been determined by the inventors that the evolutionary operations that are used to create each new generation from a preceding generation, due to their somewhat random nature, have the tendency to destroy good attributes (which are subexpressions in the case of GEP). The inventors have noted, that there is no adequate mechanism in GEP for identifying good parts of the fittest members of each generation and preserving these for the next generation. Consequently, a relatively large population and a large number of generations are required to obtain satisfactory results.

### BRIEF DESCRIPTION OF THE FIGURES

The present invention will be described by way of exemplary embodiments, but not limitations, illustrated in the accompanying drawings in which like references denote similar elements, and in which:

FIGS. 1-3 show a flowchart of an algorithm 100 for evolving a population of representations of mathematical expressions according to a first embodiment;

FIG. 4 shows a linear Polish chromosome encoding a mathematical expression;

FIG. 5 represents an expression tree equivalent of the mathematical expression encoded in the linear Polish chromosome shown in FIG. 4;

FIG. 6 shows the mathematical expression that is encoded in the linear Polish chromosome shown in FIG. 4 in standard mathematical notation;

FIG. 7 is a flowchart of a subroutine for validating a linear Polish chromosome and reporting a length of an expression encoding portion of chromosome that is used by the algorithms shown in FIGS. 1-3,8,10;

FIG. 8 is a partial flowchart of an alternative for creating derived genes that can be used in the algorithm shown in FIGS. 1-3;

FIG. 9 is a flowchart of a subroutine that is used to label the depth of each gene in an expression encoding portion of a linear Polish chromosome;

FIG. 10 is a partial flowchart of another alternative subroutine for creating derived genes that can be used in the algorithm shown in FIGS. 1-3; and

FIG. 11 is a hardware block diagram of computer on which the algorithms and routines described with reference to FIGS. 1-10 are suitably executed.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

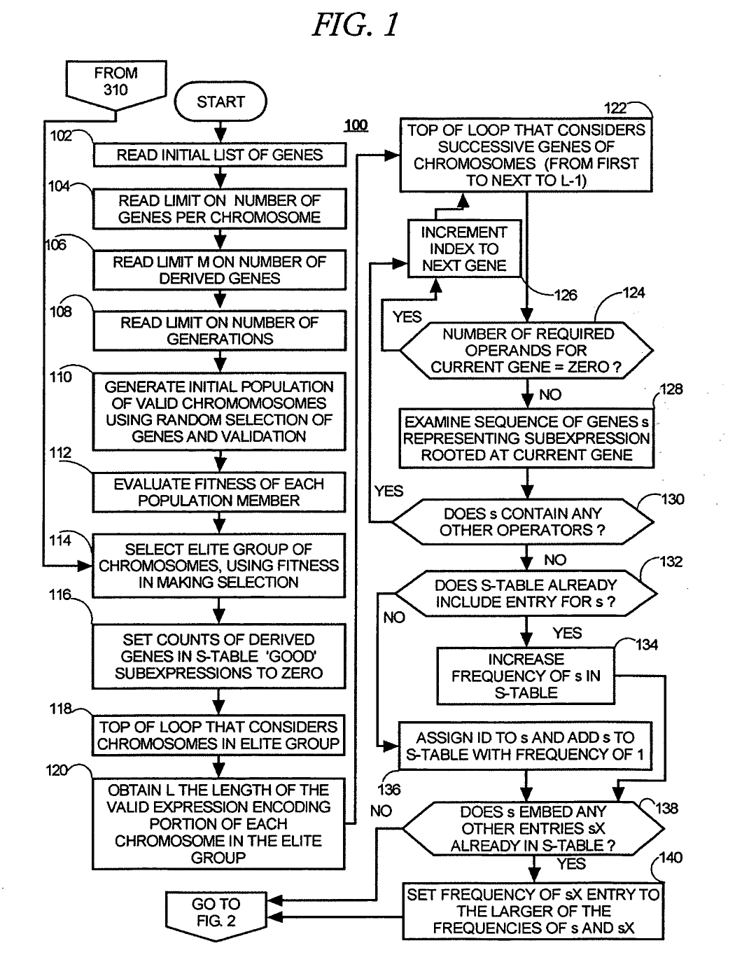

FIGS. 1-3 show a flowchart of an algorithm 100 for evolving a population of representations of mathematical expressions according to a first embodiment. The algorithm 100 shown in FIGS. 1-3 is a Gene Expression Programming (GEP) type genetic algorithm (GA). The algorithm 100 is used to determine a mathematical expression that fits data well (symbolic regression) or to determine a mathematical expressions of a rule for classifying or to determine a mathematical expression used for another purpose. For data fitting, data may include one or more sets of associated independent and dependent variable values. For classification, data used to test the one or more mathematical expressions includes one or more sets of attribute data (feature vectors, which take the place of independent variable values) and associated class identifications. In order to use a mathematical expression to perform classification, one or more ranges of values of the mathematical expression can be assigned to one or more classes.

Referring to FIG. 1, in step 102 a list of operators and operands to be used is read in. The list may be stored in a configuration file. It is appropriate for a wide variety of technical fields to include addition, subtraction, multiplication, and division among the operators read in in step 102. In a wide variety of technical fields it is also appropriate to include trigonometry functions such as sine cosine, tangent, and inverse trigonometry functions such as arcsine, arccosine, and arctangent. Note that operators may be classified according to the number of arguments (e.g., operands) upon which they operate. Other types of functions may also be included. The MAX function accepts two operands or mathematical sub expressions as arguments, evaluates the two arguments, and returns the value of the argument that is larger. The complementary MIN function may also be included.

Another type of operand, that is familiar as a flow control construct in programming, namely the IF {subexpression_one>0} THEN {subexpression_two} ELSE {subexpression_three} (succinctly referred to as the IF operator), may also be included. The latter is useful in discovering piecewise defined functions and in discovering mathematical expressions for classification. Note that the IF operator accepts three arguments, a first sub expressions used in an inequality condition, a second subexpression to be evaluated if the condition is met, and a third subexpression to be evaluated if the condition is not met.

It may be appropriate to include operators based on special functions that arise often in a specific field. For example, if the algorithm 100 is to be applied to the field of Neural Networks, it may be appropriate to include an operator based on the Sigmoid function.

Table I includes an exemplary list of operators that may be read in, in step 102. In Table I, the first column indicates names of operators, the second column indicates operator type which is equivalent to the number of arguments that an operator accepts, the third column is reserved for values (which is dependent on the values of the arguments of each operators and therefore is not filled in in Table I), the fourth column gives a cost associated with each operator, the latter being a measure of a degree to which each operator increases the complexity of mathematical expressions, and the fifth column is an index by which the operator is referenced.

TABLE I

| | | | | |
|---|---|---|---|---|
| NAME | TYPE | VALUE | COST | INDEX |

THREE OPERAND OPERATOR

| | | | | |
|---|---|---|---|---|
| IF | 3 | — | 3 | 1 |

TWO OPERAND OPERATORS

| | | | | |
|---|---|---|---|---|
| + | 2 | — | 1 | 2 |
| − | 2 | — | 1 | 3 |
| * | 2 | — | 1 | 4 |
| / | 2 | — | 1 | 5 |
| MIN | 2 | — | 2 | 6 |
| MAX | 2 | — | 2 | 7 |
| POW | 2 | — | 2 | 8 |

ONE OPERAND OPERATORS

| | | | | |
|---|---|---|---|---|
| SIN | 1 | — | 2 | 9 |
| COS | 1 | — | 2 | 10 |
| TAN | 1 | — | 2 | 11 |
| EXP | 1 | — | 2 | 12 |
| LOG | 1 | — | 2 | 13 |
| SQRT | 1 | — | 2 | 14 |
| GAUSS | 1 | — | 2 | 15 |
| SIGMOID | 1 | — | 2 | 16 |

The operands that are read in step 102 include constants and independent variables. Table II below includes an exemplary list of operands that are read in step 102. The identity of the columns in Table II is the same as in Table I. The index numbers in Table II continue the index number sequence started in Table I.

TABLE II

| | | | | |
|---|---|---|---|---|
| NAME | TYPE | VALUE | COST | INDEX |

OPERANDS

| | | | | |
|---|---|---|---|---|
| Pi | 0 | 3.1415 | 0 | 17 |
| 0 | 0 | 0.0 | 0 | 18 |
| 1 | 0 | 1.0 | 0 | 19 |

PRIME NUMBER OPERANDS

| | | | | |
|---|---|---|---|---|
| 2 | 0 | 2.0 | 0 | 20 |
| 3 | 0 | 3.0 | 0 | 21 |
| 5 | 0 | 5.0 | 0 | 22 |
| 7 | 0 | 7.0 | 0 | 23 |
| 11 | 0 | 11.0 | 0 | 24 |
| 13 | 0 | 13.0 | 0 | 25 |
| 17 | 0 | 17. | 0 | 26 |
| 19 | 0 | 19. | 0 | 27 |
| 23 | 0 | 23.0 | 0 | 28 |
| 29 | 0 | 29.0 | 0 | 29 |
| 31 | 0 | 31.0 | 0 | 30 |
| 37 | 0 | 37.0 | 0 | 31 |
| 41 | 0 | 41.0 | 0 | 32 |
| 43 | 0 | 43.0 | 0 | 33 |
| 47 | 0 | 47.0 | 0 | 34 |
| 53 | 0 | 53.0 | 0 | 35 |
| 59 | 0 | 59.0 | 0 | 36 |
| 61 | 0 | 61.0 | 0 | 37 |
| 67 | 0 | 67.0 | 0 | 38 |
| 71 | 0 | 71.0 | 0 | 39 |
| 79 | 0 | 79.0 | 0 | 40 |
| 83 | 0 | 83.0 | 0 | 41 |
| 89 | 0 | 89.0 | 0 | 42 |
| X | 0 | — | 0 | 43 |
| Y | 0 | — | 0 | 44 |

The first row (row 17 by index number) of Table II includes Pi which is included because experience has shown that it often appears in mathematical expressions related to science and engineering problems. Other appropriate constants that are significant in a wide range of fields (e.g., the natural logarithm base, e) or constants that are applicable to a particular field of study (e.g., Plank's constant) may be included in Table II if is thought there is a chance that they appear in a mathematical expression being sought. The following row (index 18) of Table II includes the zero operand. Inclusion of zero allows the algorithm 100 to effectively turn off parts of mathematical expressions that the algorithm 100 is evolving, e.g., by multiplying a sub expression by zero, without otherwise disturbing the mathematical expressions. Gene Expression Programming is sensitive to the sequence of operators and operands in a representation of mathematical expressions. According to an alternative embodiment the uno( ) function is included among the operators read in in step 102. The uno( ) function returns its argument unchanged.

The next row (index 19) of Table II includes the number one (1). One has a special role in the real number system in that any integer or rational number may be formed by summing one or dividing sums of one respectively. Thus providing one to the algorithm 100, in principle, allows the algorithm 100 to generate any numbers of the foregoing types if necessary in a mathematical expression being generated.

Table I and Table II include the raw material used by the algorithm 100 in determining a mathematical expression. The contents of Table I and II (which in practice may be represented as arrays or other data structures) will be used to generate an initial population of representations of mathematical expressions, and will be drawn from in performing mutation operations.

The next group of rows (indexes 20-42) of Table II include a sequence of prime numbers. By combining two or more of the prime numbers in products, sums, quotients, and differences, a variety of numbers may be generated by sub-expressions that are relatively simple compared to what would be needed to generate the same numbers using only the number one. Thus, the inclusion of the sequence of prime numbers in Table II tends to reduce the number of generations required for the algorithm 100 to find a mathematical expression that describes a set of technical data, or performs well as a classification rule and also tends to reduce the complexity of the mathematical expressions that are found.

The independent variables to be included in mathematical expressions generated by the algorithm 100 may be identified in a file that includes training data that is used to evaluate the fitness of programs produced by the GEP algorithm 100. A standard file format that is used for training data and includes identifications of independent variables associated with the data is known as the Academic Data Mining Research file format or ARFF. The last two entries in Table II-X and Y are exemplary independent variables. The number of independent variables in Table II corresponds to the number of independent variables in technical data for which the algorithm 100 seeks a mathematical expression. For certain problems, there may be only one independent variable or more than two. The operators and operands in Table I and II will serve as root genes that will be included in a population of chromosomes that will be evolved by the algorithm 100. Each chromosome encodes a mathematical expression. For solving typical problems on typical computers that are presently available a few hundred to a few thousand chromosomes are included in the initial and subsequent population.

Referring again to FIG. 1, in step 104 a limit on a number of genes per chromosome is read in. The maximum number of genes per chromosome sets a limit on the size of mathematical expressions encoded in the chromosomes. The maximum number of genes per chromosome also effects the amount of computer memory required to run the algorithm 100. Setting a limit on the number of genes, optionally along with other measures disclosed in co-pending application Ser. No. 10/101,814 and briefly described below, helps to control over-fitting of the mathematical expressions to training data. In block 106 a limit M on a number of derived genes is read in. Derived genes are explained further below. In block 108 a limit on a number of generations through which the population of chromosomes is evolved is read in. The limit on the number of generations can be used to control the run time of the algorithm 100. Alternatively, no limit on the number of generations is imposed, and the algorithm 100 runs until a stopping criteria is satisfied or until the algorithm 100 is terminated.

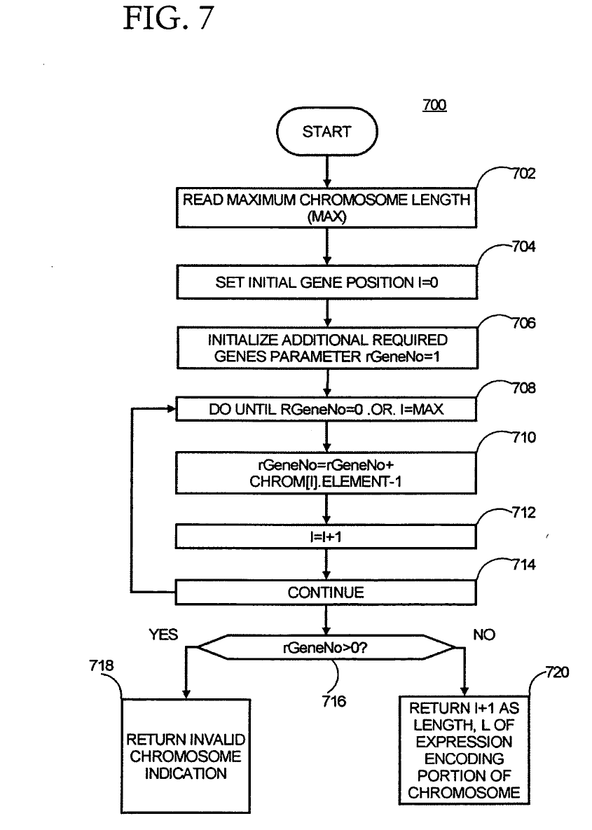

In block 110 an initial population of linear Polish chromosomes is generated by randomly selecting genes (operands and operators) from a plurality of root genes, e.g., the genes in Table 1 and Table II. Each linear Polish chromosome is checked using a validation algorithm to insure that the chromosome encodes a valid mathematical expression. A validation algorithm 700 is described below with reference to FIG. 7. If the chromosome is found to be invalid the chromosome can be replaced with another randomly generated chromosome which must also be valid, or altered and checked for validity until a valid chromosome is obtained.

As disclosed in co-pending application Ser. No. 10/101,814 each chromosome suitably includes a list of indices, (e.g., the indices in the fifth column of Table I and Table II) each of which refers to a particular gene. Using numerical indices to refer to genes is memory efficient. Also, as disclosed in co-pending application Ser. No. 10/101,814, the population of chromosomes is suitably represented by a matrix of indices, wherein each row (or alternatively each column) includes one chromosome population member.

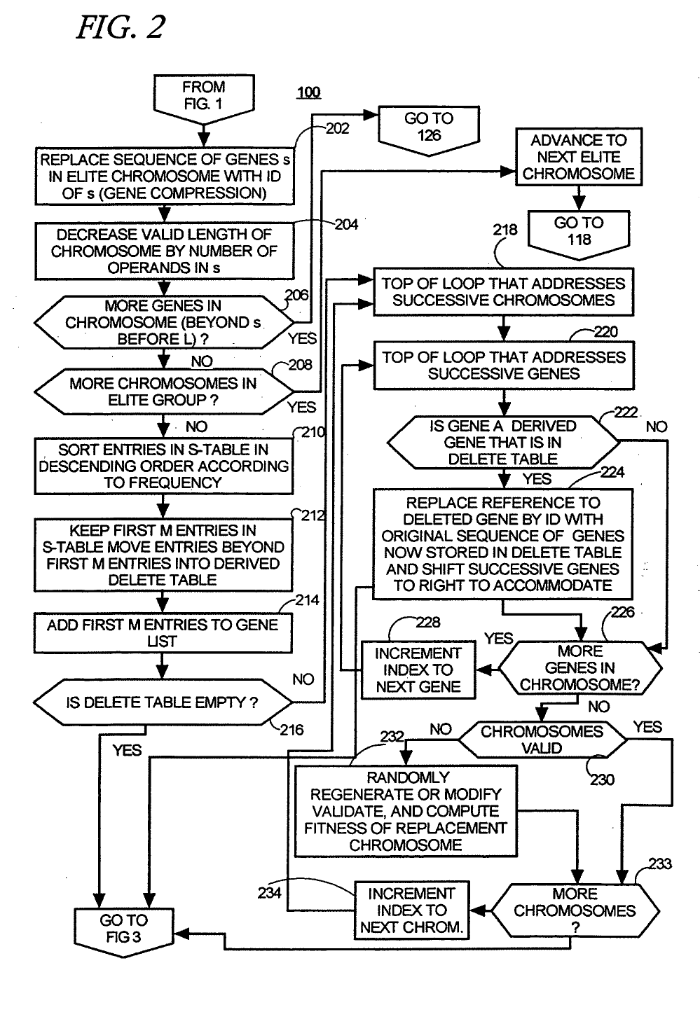

FIG. 4 shows an example of a linear Polish chromosome 400 encoding a mathematical expression. In FIG. 4, the actual operands and operators, as opposed indexes which refer to the operands and operators, are shown in the interest of clarity. The genes in the linear Polish chromosome 400 are separated by periods for easy reading. When the genetic algorithm 100 is executing in a computer, the indexes of the operands and operators shown in Table I and Table II will be used in the linear Polish chromosomes. For example the linear Polish chromosome 400 shown in FIG. 4 will take the form [14, 4, 2, 44, 43, 22, 4, 14, 5, 19, 3,43, 44, 43]. Although shown here in decimal format, the gene indexes in the linear Polish chromosomes will be represented in binary in the computer on which the genetic algorithm is executing. Representing genetic algorithm population members by arrays of integers facilitates rapid execution of evolutionary operations such as cross over, mutation and rotation.

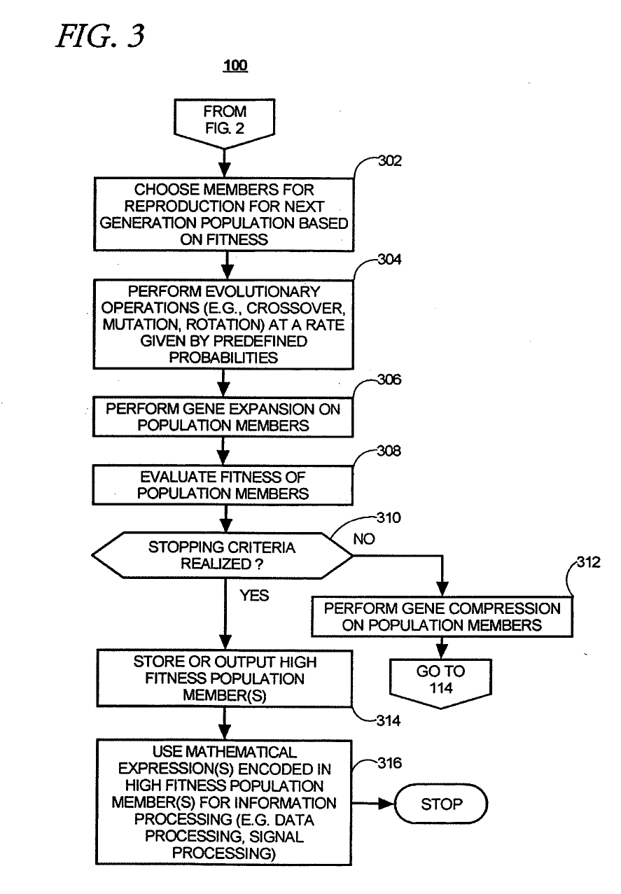

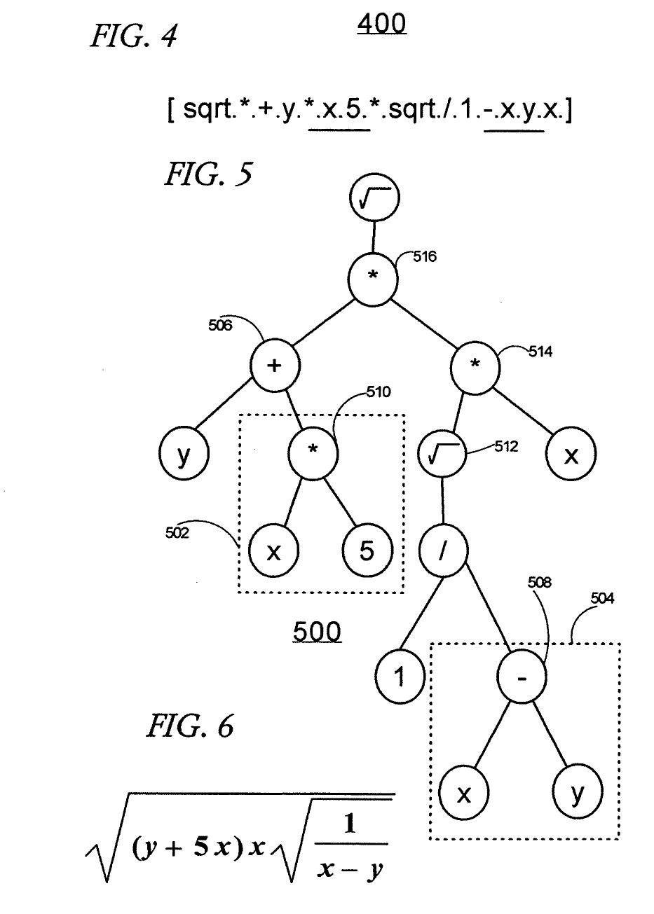

FIG. 5 includes an expression tree 500 equivalent of the mathematical expression encoded in the linear Polish chromosome 400 and FIG. 6 shows the mathematical expression that is encoded in the linear Polish chromosome 400 shown in FIG. 4 in standard mathematical notation. Note that the linear Polish chromosome encodes the expression using Polish notation. According to the rule of Polish notation the expression tree 500 is developed in a depth-first fashion using successive genes in the linear Polish chromosome 400. When the depth-first Polish notation encoding is used, evolutionary operations such as one point cross-over that are used in evolving the population of linear Polish chromosomes tend to be less disruptive. Using linear Polish chromosomes facilitates survival of mathematical subexpressions of various sizes. Using the depth-first Polish notation will generally lead to accelerated population fitness improvement. Note that operators can have operands or other operators as arguments.

Referring again to FIG. 1, in block 112 the fitness of each of the chromosomes of the initial population of chromosomes is evaluated. In applying the algorithm 100 to finding a mathematical expression to fit data, a first basic measure of fitness relates to the ability of the mathematical expression encoded in each chromosome to fit training data. The training data suitably includes multiple sets of data, each of which includes values for each independent variable and an associated dependent variable value. In order to evaluate the fitness of the expression encoded in each chromosome, the values of independent variables are plugged into the expression and the difference between the value of the expression and the associated dependent variable value from the training data is calculated. The squares of the differences calculated from the multiple sets of data are suitably summed. The resulting sum can be used directly as a measure of fitness, or passed through a function that maps the resulting sum to a predetermined range, e.g., zero to one.

As taught in co-pending application Ser. No. 10/101,814 a second fitness measure that relates to the complexity of each mathematical expression is suitably derived by summing a cost (e.g., from the fourth column in Table I and Table II) associated with the operators in the mathematical expression. The resulting sum can also be passed through a function that maps the resulting sum into a predetermined range, e.g., zero to one. Each fitness measure can be mapped into the range zero to one by dividing the average of the fitness measure over the population by the sum of the fitness measure for a particular chromosome and the average. If two or more fitness measures are to be used, mapping the fitness measures into a predetermined range is useful if the two or more fitness measures are to be combined into an overall fitness measure, because mapping makes the scales of the two or more fitness measures comparable.

In applying the algorithm 100 to finding a mathematical expression that correctly classifies objects (represented by vectors of independent variable values) a measure of fitness that depends on the ability of the mathematical expression to correctly identify members of a class that the mathematical expression is meant to identity, and also not misidentify objects outside the class as belonging to the class is suitably used. The above-described second fitness measure may also be used for classification applications of the algorithm. Methods of using GEP to derive classification rules are more fully described in Chi Zhou et al, “Evolving Accurate and Compact Classification Rules with Gene Expression Programming”, IEEE Transactions on Evolutionary Computation, Vol. 7, No. 6., December 2003.

In block 114 an elite group of chromosomes is selected by choosing a predetermined number (e.g., four) chromosomes which have the highest fitness, as determined in block 112. In block 116 counts of each derived gene in a table of derived genes (referred to hereinbelow as the S-table) are zeroed. The derived genes are derived from successive elite groups selected from successive populations of chromosomes. The first time block 116 is reached there will not yet be any entries in the S-table. A representation of the S-table is shown as Table III.

TABLE III

| NAME | LIST | FREQUENCY | INDEX |
|---|---|---|---|
| D0 | *.x.5 | 1 | 45 |
| D1 | −.x.y | 1 | 46 |
| . . . | . . . | . . . | |

In Table III the first column indicates a name of derived genes, the second column gives a list of genes which make up each derived gene, the third column gives the frequency of the derived genes listed in the table, and the fourth column gives an index that is used to represent each derived gene in chromosomes. The lists of genes in the second column encode subexpressions in linear Polish form. Optionally, another column, which gives the cost associated with each derived gene, is provided. The cost can, for example be equal to the sum of the costs of the operators in the derived genes. In practice, an index such as in the fifth column of Table I and Table II can be used as the name of the derived gene. It is the frequencies listed in the third column of Table III that are zeroed in block 116. The derived genes represent subexpressions that are identified in elite chromosomes. For each new generation of chromosomes, the derived genes are retained or removed from the S-table based on the prevalence of the derived genes in the new generation. It is inferred from the presence of the derived genes in the elite group that they are good subexpressions which are to be propagated to later generations of chromosomes, in order to accelerate the learning rate of the algorithm 100, in other words in order to reduce the number of generations required to satisfy a given stopping criteria. A first derived gene named D0, and a second derived gene D1 are shown in Table II. The first and second derived genes correspond to gene sequences that are underlined in chromosome 400 shown in FIG. 4, and represent subtrees 502 and 504 respectively in FIG. 5

Block 118 is the top of a loop that considers successive chromosomes in the elite group. In block 120 a length (in terms of number of genes) of a valid expression encoding portion of each chromosome in the elite group is obtained. In FIG. 1 a variable L represent the length. The length L may have been stored after having been determined in the course of executing block 112. The length L is determined by the aforementioned validation algorithm which is described below with reference to FIG. 7. Block 122 is the top of a loop that considers successive genes of the chromosomes in the elite chromosomes starting from a gene at the second position in each elite chromosome and ending at the gene preceding the last gene of the expression encoding part of the chromosome. Block 124 is a decision block the outcome of which depends on whether the number of required arguments for the current gene is zero (in other words if the current gene is an operand). If so, then in block 126 an index that points to successive genes in the elite chromosome is incremented and the algorithm 100 loops back to block 122 in order to try and find an operator gene. When an operator gene is found in block 124, the algorithm 126 proceeds to block 128 in which a sequence of genes in the elite chromosomes that represents a subexpression that is rooted in the operator gene found in block 124 is examined. As shown in FIGS. 5-7 in a Polish notation chromosome subexpressions are represented by a sequence of genes. For example the subexpression y+5x of the mathematical expression shown in FIG. 6 is represented by the sequence +,y,*,x,5 in the Polish notation chromosome shown in FIG. 4. In the expression tree shown FIG. 5 the subexpression is represented by a subtree that is rooted in the outer operator, i.e. plus operator 506. Block 130 is a decision block the outcome of which depends on whether the sequence of genes examined in block 128 includes any other operator genes. If so then, the algorithm loops back to block 128 in order to advance to a next gene. If, on the other hand, the sequence of genes examined in block 128 does not include any other operator genes, then in block 132 the S-table is checked to see if the sequence of genes is included in the S-table. The sequence of genes is now considered a candidate derived gene. Optionally before checking the S-table, the candidate derived gene is transformed into a canonical form, for example for operators that have the commutative property the operands can be sorted e.g., by index. A sequence of genes might already be in the S-table if it was extracted from another elite chromosome selected from the current generation or a preceding generation of chromosomes. If it is determined in block 132 that the S-table already includes the candidate derived gene, then in block 134 the frequency of the derived gene in the S-table is increased. If, on the other hand, it is determined in block 132 that the S-table does not already include the candidate derived gene, then in block 136 a next available ID, e.g. an index akin to the identifying index the fifth column of Table I and Table II is assigned to the candidate derived gene, and the candidate derived gene added to the S-table. Following both block 134 and block 136 is decision block 138, the outcome of which depends on whether the candidate derived gene includes another derived gene denoted sX (generated during a preceding generation) as an operand. If so then in block 140 the frequency of the other derived gene sX is set to the larger of the frequency of the candidate derived gene and the previous frequency of the other derived gene sX. After executing block 138 and block 140, if necessary, the algorithm 100 proceeds to block 202 in FIG. 2. In block 202 the elite chromosome corresponding to the current iteration of the loop begun in block 118 is altered by replacing the sequence of genes that corresponds to the candidate derived gene identified in block 132 with the ID assigned to the candidate derived gene in block 136. This step is referred to as gene compression because a sequence of genes in the elite chromosome is replaced by an ID that represents the sequence of genes. In block 204 the valid length L of the elite chromosome that was obtained in block 120 (or previously decreased in a previous iteration of the loop commenced in block 122) is decreased by the number of operands in s to account for the gene compression. Block 206 is a decision block, the outcome of which depends on whether there are more genes beyond the candidate derived gene but before the last (L^{th}) gene in the expression encoding portion of the elite chromosome under consideration. If so then, the algorithm proceeds to block 126 in which the index that points to successive genes is incremented, and the algorithm 100 proceeds as previously described. If on the other hand, it is determined in block 206 that there are no more genes to be processed, the algorithm 100 branches to decision block 208 the outcome of which depends on whether there are more elite chromosomes to be processed. If so then in block 210 the algorithm 100 is advanced to the next elite chromosome and thereafter loops back to block 118 in order to processes the next elite chromosome as previously described. If all of the elite chromosomes have been processed, the algorithm continues with block 210 in which all of the entries (derived genes from previous generations and candidate derived genes extracted from the elite group of the current generation) are sorted according to frequency. In block 212 the first M (limit read in block 106) derived genes, having the highest frequencies are kept in the S-table and derived genes beyond the first M are moved into a derived gene delete table. Thereafter in block 214 the first M derived genes are added (or considered part of) the root gene list. Genes are selected from the root gene list at random to replace other genes when random mutation of chromosomes is performed. The root gene list is also used to randomly generate chromosomes to replace chromosomes that become invalid as a result of other evolutionary operations (e.g., rotation, crossover).

Block 216, is a decision block, the outcome of which depends on whether the delete table is empty. If the delete table is not empty, then the algorithm 100 proceeds to block 218 which is the top of a loop that processes each chromosome in the elite group and optionally each chromosome in the current population. Block 220 is the top of a loop (nested within the loop commenced in block 218) that treats each gene (at least in the expression encoding portion) of each chromosome. A first decision block 222 within the nested loops determines if a gene being addressed is a derived gene that is in the delete table. If so, then in block 224 an index representing the derived gene in the chromosome is replaced with the sequence of genes (e.g., from the second column of Table III) that make up the derived gene, and genes following the deleted gene are shifted to the right to accommodate the sequence of genes. The latter process can be referred to as “gene expansion”. After block 224, or in the case of negative outcome in block 222, then the algorithm proceeds to block 226. Block 226 is a decision block, the outcome of which depends on whether there are more genes in (at least the expression encoding portion of) the chromosome. If so then the algorithm 100 proceeds to block 228 in which an index that points to successive genes in the chromosome being processed is incremented and the algorithm loops back to block 220 in order to process a next gene in the chromosome and proceeds as described above.

If it is determined in block 226 that there are no more genes in the current chromosome, then the algorithm 100 branches to decision block 230 which tests if, after gene expansion, the chromosome being addressed remains valid. Because the number of genes in chromosome is limited (according to the limit read in block 104), when deleted genes are replaced by multiple genes each deleted derived gene represents, chromosome can become invalid. Chromosomes are invalid if there is an insufficient number of operands to provide arguments to all operators. Necessary operand genes can be lost by, in effect, being shifted to the right beyond the maximum allowed chromosome length in order to accommodate insertion of genes which deleted derived genes represent. Chromosome validity is suitably tested using the validation algorithm which is described more fully below with reference to FIG. 7. Alternatively, validity is tested after each gene expansion.

If it is determined in block 230 that the chromosome being addressed is not valid, then in block 232 the chromosome is modified or a replacement chromosome randomly generated and in either case validated. One way to modify a chromosome is to replace the last operator in the chromosome with an operand. Because there is no guarantee that a randomly generated chromosome is valid, random generation of a replacement chromosome may need to be repeated until a valid chromosome is obtained. The fitness of valid chromosomes obtained in block 232 is also computed. After executing block 230 and block 232 if needed, the algorithm proceeds to decision block 233 which tests if there are more chromosomes (in at least the elite group) to be processed. If so then in block 234 an index that points to successive chromosomes is incremented and the algorithm 100 loops back to the top of the loop that addresses successive chromosomes 218, in order to process a next chromosome.

If, on the other hand, it is determined in block 233 that there are no more chromosomes to be processed, then the algorithm 100 continues with block 302 in FIG. 3. In block 302 chromosomes are chosen for reproduction in a next generation population based on their fitness. (Recall that the fitness of each population member was computed initially in block 112, and computed for modified or replacement chromosomes in block 232) Chromosomes are suitably selected for reproduction using a stochastic remainder method. In the stochastic remainder method at least a certain number Pᵢ of copies of each ith population member are selected for replication in the next generation. The number Pᵢ is given by the following equation:

$${P}_{i} = Trunc ( N * \frac{{F}_{i}}{{\sum }_{k = 1}^{N} {F}_{k}} ) \qquad EQU . 1 \text{:}$$

where, N is the number of population members in each generation

and
Trunc is the truncation function.

The sum in the denominator of equation 1 is taken over the entire current population. The fractional part of the quantity within the truncation function in equation 1 is used to determine if any additional copies of each population member (beyond the number Pi of copies determined by equation one) will be replicated in the next generation. The aforementioned fractional part is used as follows. The fractional parts for the population members are used in succession. For each fractional part, a random number between zero and one is generated. If the fractional part exceeds the random number then an addition copy the population member associated with the fractional part is added to the next generation. The number of selections made using random numbers and the fractional parts is adjusted so that successive populations maintain the total number of members N. Using the above described stochastic remainder method leads to selection of population members for replication based largely on fitness, yet with a degree of randomness. The latter characteristics echo natural selection in biological systems.

In block 304 evolutionary operations such as one or two point crossover, mutation, and/or rotation are performed at rates given by predetermined probabilities on the chromosomes which were selected for reproduction in the next generation. When the evolutionary operations are performed the linear Polish chromosomes are in the form of arrays of indexes (e.g., the indexes in the fifth column of Table I and Table II and the forth column of Table III.). In one point crossover, genes sequences following (or preceding) a particular gene position (which can be randomly selected) are exchange between two chromosomes (which can be randomly selected). Two point crossover is similar but gene sequences between to positions are exchanged. Crossover operations are analogous to the exchange of genetic material in reproduction in nature. In mutation a gene at a particular position (which can be randomly selected) is changed to a different gene which is typically randomly selected. Mutation in GEP is analogous to mutation which can occur in nature in the course of copying DNA. In rotation, a circular shift is used to change the position of genes in a chromosome. Note that at the time the evolutionary operations are performed in block 304, the derived genes will be represented by a single token (e.g., index) in the chromosomes and therefore the evolutionary operations will not disrupt the internal structure of the derived genes. Thus, the derived genes which are assumed, because of their presence in the elite group, to contribute significantly to high fitness are preserved for reproduction in the next generation.

In block 306 gene expansion is performed on the chromosome population members. Gene expansion is performed in order prepare for fitness evaluation, which entails evaluation of mathematical expression that each chromosome encodes. (Alternatively, gene expansion is not performed in block 306 and the evaluation of derived genes is handled separately, and the results passed to a process that evaluates the chromosomes.)

In block 308, the fitness of each population member is evaluated as was done in block 112 described above. Block 310 is a decision block that tests whether a stopping criteria is realized. The stopping criteria may require that at least one population member has attained a fitness that satisfies a predetermined inequality (e.g., is numerically greater than or less than a predetermined value, depending on how the fitness is defined). Alternatively, the stopping criteria may require that an average fitness of the population satisfies a predetermined inequality. If the stopping criteria, is not satisfied, then the algorithm 100 proceeds to block 312. In block 312 gene compression is performed. Performing gene compression in block 312 allows derived genes to appear as operands in derived genes that are identified in a subsequent generation. After block 312 the algorithm 100 loops back to block 114 and repeats the process previously described.

If the stopping criteria is satisfied then in block 314 information about one or more (e.g., the fittest) chromosomes is suitably output (e.g., on a display or printer) and/or stored (e.g., in a hard drive). Thereafter, in block 316 one or more mathematical expressions encoded in one or more of the high fitness chromosomes is used for information processing. The information processing can be data processing or signal processing. In order to perform information processing the mathematical expression(s) encoded in one or more high fitness chromosomes is suitably implemented in software (e.g., using a programmed processor) or hardware (e.g., in an Application Specific Integrated Circuit).

Thus, the algorithm 100 will continue to evolve the population of chromosomes until the stopping criteria is satisfied, or until the algorithm 100 is terminated.

FIG. 7 is a flowchart of a subroutine 700 for validating a linear Polish chromosome and, reporting a length of an expression encoding portion of chromosome. As noted above subroutine 700 is used by the algorithm 100 in executing blocks 120 and 230. Subroutine 700 allows the size of the expression encoding portion of a linear Polish chromosome to be determined without having to build an expression tree. In block 702 the limit (here denoted ‘MAX’) on the number of genes per chromosome is read. In block 704 an index I which points to successive genes of a chromosome is initialized to zero. The 0^{th} gene of each chromosome is located at the root position. In block 706 a variable ‘rGeneNo’ is initialized to one. The variable rGeneNo indicates a number of additional genes required to complete an expression encoding portion of a chromosome. As the routine 700 processes successive genes in a chromosome, the value of rGeneNo varies to reflect the number of additional operands required to terminate all operator genes up to the current (ith) gene position.

Block 708 is the start of a program loop that is repeated until rGeneNo=0 (which happens when the end of an expression encoding portion of a chromosome has been reached) or until I=MAX (which happens when the end of the chromosome has been reached. (If the end of the chromosome is reached without passing enough operand genes to terminate all operator genes that have been encountered, an incomplete and therefore invalid mathematical expression is encoded in the chromosome). In each pass through the program loop, in block 710, the rGeneNo variable is incremented by one less than the number of operands required by the current operator (given in the TYPE column of Table I and Table II), and in block 712 the index that points to successive genes is increment by 1. Block 712 denotes the bottom of the program loop.

Block 716 is a decision block, the outcome of which depends on whether, after the program loop has been exited, the value of the variable rGeneNo is greater than zero. A value greater than zero, indicates that more operand genes, than are present in a chromosome, would be necessary to terminate all of the operator genes present in the chromosome. If it is determined in block 716 that the value of rGeneNo is greater than zero, the routine 700 proceeds to block 718 in which an invalid chromosome indication is returned (e.g., to algorithm 100). If on the other hand, it is determined in block 716 that rGeneNo is equal to zero, then the routine branches to block 720 in which the value of I plus one is returned as the length (number of genes) of the expression encoding portion of the chromosome that was processed by the routine 700. Table IV below illustrates the operation of the routine.

TABLE IV

| Part of Chromosome to be processed | I | Current Gene | Required Operands | RGeneNo |
|---|---|---|---|---|
| sqrt.*.+.y.*.x.5.*.sqrt./.1.−.x.y.x.3.x.5 | 0 | sqrt | 1 | 1 |
| *.+.y.*.x.5.*.sqrt./.1.−.x.y.x.3.x.5 | 1 | * | 2 | 2 |
| +.y.*.x.5.*.sqrt./.1.−.x.y.x.3.x.5 | 2 | + | 2 | 3 |
| y.*.x.5.*.sqrt./.1.−.x.y.x.3.x.5 | 3 | y | 0 | 2 |
| *.x.5.*.sqrt./.1.−.x.y.x.3.x.5 | 4 | * | 2 | 3 |
| x.5.*.sqrt./.1.−.x.y.x.3.x.5 | 5 | x | 0 | 2 |
| 5.*.sqrt./.1.−.x.y.x.3.x.5 | 6 | 5 | 0 | 1 |
| *.sqrt./.1.−.x.y.x.3.x.5 | 7 | * | 2 | 2 |
| sqrt./.1.−.x.y.x.3.x.5 | 8 | sqrt | 1 | 2 |
| /.1.−.x.y.x.3.x.5 | 9 | / | 2 | 3 |
| 1.−.x.y.x.3.x.5 | 10 | 1 | 0 | 2 |
| −.x.y.x.3.x.5 | 11 | − | 2 | 3 |
| x.y.x.3.x.5 | 12 | x | 0 | 2 |
| y.x.3.x.5 | 13 | y | 0 | 1 |
| x.3.x.5 | 14 | x | 0 | 0 |

In Table IV the first column shows a portion of an exemplary chromosome to be processed at the beginning of the program loop commenced in block 708, the second column indicates the value of the I variable at the start of the program loop, the third column shows the gene in the ith position, the fourth column shows required operands for the ith gene, and the fifth column shows the value of the rGeneNo variable at the start of the program loop. The example in Table IV assumes a maximum chromosome length of 18 genes. The expression encoding portion of the exemplary chromosome is 15 genes long, extending from gene position 0 to gene position 14. When the gene 14 is reached the variable rGeneNo attains a value of zero and the program loop (blocks 708-714) is exited, whereupon the routine executes decision block 716.

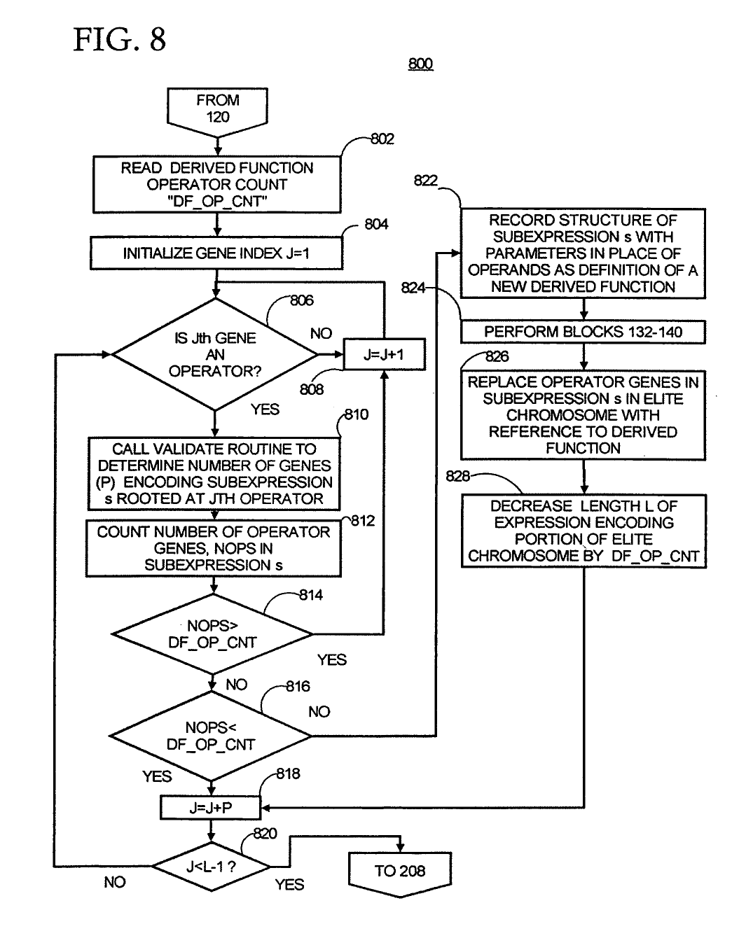

FIG. 8 show a partial flowchart of an alternative subroutine 800 for creating derived genes that can be used in the algorithm shown in FIGS. 1-3. Whereas in blocks 122-206 in FIGS. 1-2 derived genes that are based on minimum trees (i.e. a single operator and operands for the single operator) in the alternative shown in FIG. 8 derived genes are created from the subexpressions that include multiple operators. According to FIG. 8, unlike what is shown in FIGS. 1-2, the definitions of derived genes include operators without the specific operands originally associated with the operator genes in the elite chromosomes. Such derived genes are referred to as derived functions. According to an alternative embodiment derived functions are allowed to included operands that are variables.

Referring to FIG. 8, the alternative subroutine 800 continues from block 120 in FIG. 1 with block 802 in which an integer (named “DF_OP_CNT” in FIG. 8) specifying a number of operators that each derived function is to have is read. In block 804 an index j that specifies gene position within each chromosome is set to 1. (Note that the gene position indexing starts at zero at the first (root position) gene, so setting j to 1 starts the subroutine 800 at the second gene.) Block 806 is a decision block the outcome of which depends on whether the gene in the jth position is an operator. If not then j is incremented in block 808 until an operator is encountered. When an operator is encountered the subroutine 800 continues with block 810, in which the chromosome validating routine 700 (shown in FIG. 7) is called with the portion of the elite chromosome being processed extending from gene position j to gene position L−1 the last gene in the expression encoding portion. In this instance, the validating routine is used, not to determine the length of entire expression encoding portion of the elite chromosome, but rather to determine the length (denoted P in FIG. 8) of the portion of the elite chromosome that encodes a subexpression (denoted s) that is rooted in the jth gene. (Note that P is equal to one plus the value of I returned by routine 700 because routine 700 counts from zero. By way of illustration the plus operator 506 shown in FIG. 5 roots a subexpression: y+5x that is encoded by the following sequence of five genes: +, y, *, x, 5. Calling subroutine 700 with the gene sequence +,y,*,x,5,sqrt,/,1,−,x,y,x in block 810 would return a length L=I+1=5.

In block 812 the number of operator genes (denoted NOPS) in the subexpressions is counted. By way of example, the subexpression rooted in the plus operator 506 includes two operators. Block 814 is a decision block the outcome of which depends on whether the operator count NOPS in the subexpression is exceeds the number operators DF_OP_CNT, read in block 802, that each derived function is to have. If so, then the gene position index j is incremented by one in block 808 and thereafter the subroutine continues from block 806 as previously described. Thus, if the number of operators in the subexpression exceeds DF_OP_CNT, then the routine looks for a smaller subexpression within the previous subexpression that has the required number (DF_OP_CNT) of operators. Note that derived functions are suitably permitted to include other derived functions, and the operators that the included derived function includes are not counted towards DF_OP_CNT of the including derived function.

If on the other hand it is determined in block 814 that the number of operator genes NOPS in the subexpression s does not exceed the required number of operators for defined functions DF_OP_CNT, then the subroutine 800 continues with decision block 816 the outcome of which depends on whether the number of operators NOPS in the subexpression s is less than the required number of operators for defined functions DF_OP_CNT. If so, meaning that there are insufficient operators in s, then in block 818 j is incremented by p to advance beyond the subexpression s, then in block 820 j is compared to L−1, the last gene position of the expression encoding portion of the elite chromosome, to determine if the end of the expression encoding portion has been reached. If not then the subroutine loops back to block 806 and continues processing the elite chromosome. If it is determined in block 820 that the end of the elite chromosome has been reached, then the subroutine branches to block 208. (If more elite chromosomes remain to be processed the subroutine 800 will be reentered at block 802 from block 120)

If it is determined in block 816 that the number of operator genes NOPS in the subexpression s is not less than the required number of operators DF_OP_CNT (which because of the arrangement of blocks 814 and block 816 means that the number of operator genes NOPS is equal to the required number of operators DF_OP_CNT), the subroutine 800 continues with block 822 in which the structure of subexpression s with parameters in place of operands is recorded as a definition of a new derived function. Table V includes information of about example derived genes, that would be extracted from the chromosome shown in FIG. 4 by the subroutine 800 if DF_OP_CNT were set to 2:

TABLE V

| | | | PARAM- | | |
|---|---|---|---|---|---|
| | | | ETERIZED | | |
| | | | LINEAR | | |
| | | | POLISH | | |
| | | | REPRE- | | |
| NAME | TYPE | LIST | SENTATION | FREQUENCY | INDEX |
| F0 | 3 | +.y.*.x.5 | +.po.*p1.p2 | 1 | 45 |
| F1 | 3 | /.1.−.x.y | /.po.−.p1.p2 | 1 | 46 |
| . . . | | . . . | . . . | | |

In Table V a first column gives a name, a sixth column gives an identifying index which would be used in representing the derived function in chromosomes, a second column gives the number of operands that each derived function accepts, a third column gives a list of genes from which the derived function was derived, a fourth column gives a linear Polish notation representation of the derived function with parameters po, p1, p2 substituted for operands, and a fifth column gives the frequency of the derived function. In practice the entries in the fourth column would reflect the total number of occurrences of each derived function in the elite group of chromosomes of a particular generation. The record made in block 822 suitably includes the information in the second through fifth columns of Table IV.

For alternative subroutine 800 the S-table referred to in the context of FIGS. 1-3 suitably has a structure that parallels Table V. Block 824 in subroutine 800 stands for the execution of blocks 132-140 shown in FIG. 1 and described above. In block 826 the operator genes in the subexpression s are removed from the chromosome and an ID referencing to the derived function (e.g., the index from the fifth column of Table IV) is inserted into the chromosome before the operands of the subexpression s. The latter step is an alternative form of gene compression. Block 826 does not alter the mathematical expression that is encoded in the elite chromosome because the derived function represents the operators that have been removed and their arrangement in the subexpression s. In block 828 the variable L representing the length of the expression encoding portion of the elite group chromosome being processed is decreased by the DF_OP_CNT. After executing block 828 the subroutine 800 branches to block 818 and continues executing as previously described. Thus, if the subexpression s was not at the end of the expression encoding portion of the elite chromosome, the subroutine 800 will examine the remainder of the elite chromosome to determine if more derived functions having DF_OP_CNT operators can be defined.

The subroutine 800 provides a way by which larger parts of the elite chromosomes can be identified and, if selected for preservation based their frequency of occurrence, can be protected from the vicissitudes evolutionary operations (e.g. mutation, cross-over). This will lead to greater rates of adaptation and fitness improvement, and thus lower the time required to complete execution of the genetic algorithm 100.

When a particular derived function found by the alternative subroutine 800 is to be expanded in a chromosome in block 224, the linear Polish representation (in the third column of Tables V and VI) corresponding to the particular derived function is looked up and the parameters in the linear Polish representation are replaced (in order) by the operands in the chromosome following the reference (e.g. by index) to the particular derived function and the resulting gene sequence is inserted into the chromosome, after shifting genes that follow the operands to the left, in order to accommodate the insertion.

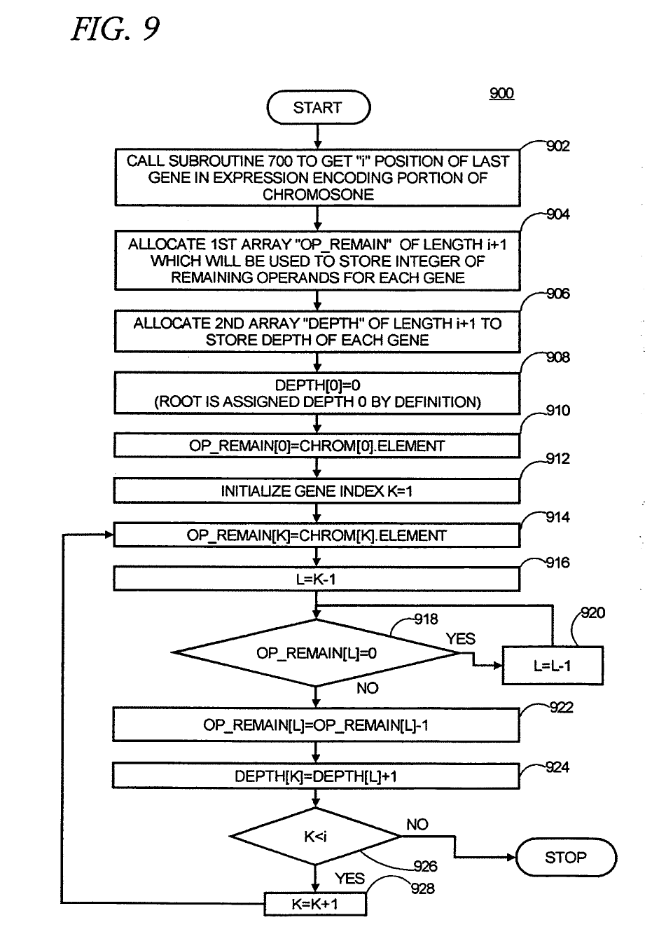

FIG. 9 is a flowchart of a subroutine 900 that is used to label the depth of each gene in an expression encoding portion of a linear Polish chromosome. Subroutine 900 determines what the depth of each gene in a linear Polish chromosome representation of an expression would be if the expression were represented as an expression tree (such as shown in FIG. 5), without having to build the expression tree from the linear Polish chromosome. In block 902 the subroutine 700 is called to get “i” the gene position index of the last gene in the expression encoding portion of a linear Polish chromosome being processed. (Because gene position indexing starts at zero, “i” is one less than the length of the expression encoding portion of the chromosome.)

In block 904 a first array, called “OP_REMAIN” of length i+1 is allocated. The OP_REMAIN array is a temporary work space array which will be used to store a number of operands that remain to be found for each gene. (Note that the elements in OP_REMAIN corresponding to operands will be set to zero).

In block 906 a second array, called “DEPTH of length i+1 is allocated. The DEPTH array is the output of the subroutine 900. After the subroutine 900 has processed a linear Polish chromosome, the depth array will contain the depths of each gene in the linear Polish chromosome. Depth is defined as the number of edges between a gene and the root gene in an expression tree (graph) representation of the expression encoded in the linear Polish chromosome. The OP_REMAIN array and the DEPTH array suitably use the same indexing as the linear Polish chromosomes, i.e. the indexing starts with zero at the first position.

In block 908 the zeroth entry of the DEPTH array is set to zero, because the depth of the root position gene is zero by definition.

In block 910 the zeroth entry of the OP_REMAIN array is set to the number of operands that the roof position gene accepts. In FIG. 9 the syntax CHROM[k].ELEMENT stands for the number of arguments that a gene in the K^{th} position requires. In Tables I-III, V, VI the number of operands that each gene requires is listed in the second column. Operands themselves require zero operands.

In block 912 an index K that points to successive genes in a linear Polish chromosome is initialized to one so as to point to the second gene.

Block 914 is the start of a loop that processes successive genes in a linear Polish chromosome. In block 914 the element of the OP_REMAIN array for a K^{th} gene of the linear Polish chromosome is set to the number of operands that the gene requires.

In block 916 an index L that points to prospective parents of the K^{th} gene is initialized to K−1. Following block 916, decision block 918 tests if the element of the OP_REMAIN array for the L^{th} gene is zero (meaning that all arguments of the L^{th} gene have already been located in a portion of the linear Polish chromosome preceding the K^{th} gene). If the L^{th} element of the OP_REMAIN array is zero, then, in block 920 L is decremented by one and decision block 918 is executed again. Execution of blocks 918 and 920 continues until a gene for which the number of arguments that remain to found is non zero is found. When a gene with a non-zero entry in the OP_REMAIN array is found (meaning that the parent of the K^{th} gene has been found) the subroutine 900 continues with block 922 in which the OP_REMAIN entry for the L^{th} gene is decremented by one (because the K^{th} gene is another argument for the L^{th} gene) and thereafter in block 924 the depth of the K^{th} gene is set equal to one plus the depth of the L^{th} gene. Because the K^{th} gene is a direct child of the L^{th} gene the depth of the K^{th} gene is one more than the depth of the L^{th} gene).

Having determined the depth of the K^{th} gene, block 926 determines if K is less than i, i.e. if there are more genes remaining in the expression encoding portion of the chromosome being processed. If so, then in block 928 K is incremented to advance to the next gene, and the subroutine loops back to block 914 in order to process the next gene as described above. If on the other hand it is determined in block 926 that the end of the expression encoding portion of the chromosome has been reached then the subroutine 900 terminates.

After the subroutine 900 has finished processing a chromosome the OP_REMAIN array will be zero filled, and the DEPTH array will contain integers identifying the depth of each gene in the expression encoding portion of the chromosome. In Table VI below, the first column indicates gene position the second column shows the gene at each position in the linear Polish chromosome shown in FIG. 4 and the third column indicates the depth of each gene. The third column is the depth array that would be generated by the subroutine 900 operating on the gene shown in FIG. 4.

TABLE VI

| GENE | | |
|---|---|---|
| POSITION | GENE | DEPTH |
| 0 | SQRT | 0 |
| 1 | * | 1 |
| 2 | + | 2 |
| 3 | y | 3 |
| 4 | * | 3 |
| 5 | x | 4 |
| 6 | 5 | 4 |
| 7 | * | 2 |
| 8 | sqrt | 3 |
| 9 | / | 4 |
| 10 | 1 | 5 |
| 11 | − | 5 |
| 12 | x | 6 |
| 13 | y | 6 |
| 14 | x | 3 |

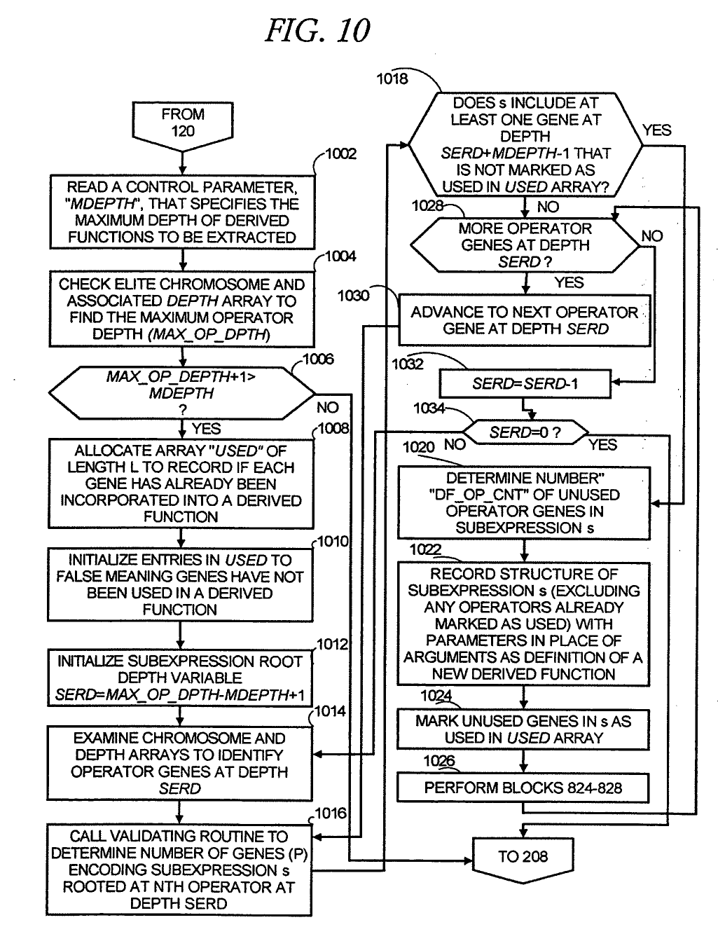

FIG. 10 is a partial flowchart 1000 of another alternative subroutine for creating derived genes that can be used in the algorithm shown in FIGS. 1-3. According to this alternative the partial flowchart 1000 takes the place of blocks 122 through 206 shown in FIGS. 1-2. The subroutine shown in FIG. 10, like that shown in FIG. 8, extracts derived functions from the elite chromosomes, however the criteria applied by the subroutine shown in FIG. 10 is different from criteria applied by the subroutine shown in FIG. 8. Whereas the subroutine shown in FIG. 8 uses subtrees that have a specified number of operators as the basis for derived functions, the subroutine shown in FIG. 10 forms each derived function from an expression tree fragment that spans a specified depth range (e.g. a fragment that spans three depth levels).

Referring to FIG. 10, in block 1002 a control parameter MDEPTH that specifies the depth range of derived functions that are to be created is read. For example MDEPTH=2 would require that each derived functions to be created be based on a fragment of the expression tree encoded in a chromosome that includes operators at two adjacent depth levels (e.g., depth=2 and depth=3 or depth=5 and depth=6).

In block 1004 an elite chromosome being processed and an associated depth array generated by subroutine 900 is checked to find the maximum depth at which an operator gene is found in the elite chromosome. The maximum depth at which an operator is found is stored in a variable MAX_OP_DPTH. By way of example, a minus operator 508 of the linear Polish chromosome 400 (represented in FIG. 5 as an expression tree) is at depth level five which is the maximum depth level of an operator in the linear Polish chromosome 400.

In block 1006 MDEPTH is compared to MAX_OP_DPTH+1. The +1 is due to the fact that depth level numbering starts with zero. (Alternatively, the +1 can be left out in order to require that, excluding the root gene, the elite chromosome has enough depth levels to form derived function with MDPETH depth levels) Block 1006 test if there are enough depth levels in the elite chromosome to extract derived functions having MDEPTH levels. If the outcome block 1006 is negative, the subroutine 1000 ceases processing the elite chromosome being processed and branches to block 208 in order to process any elite chromosomes that remain to be processed. If there are enough depth levels to form derived functions with MDEPTH levels, then the subroutine 1000 proceeds to block 1008.

In block 1008 an array called USED of length L is allocated. (Recall that L, determined in block 120 is the length of the expression encoding portion of the elite chromosome.) Alternatively the USED array can be allocated at the beginning of the algorithm 100 and have a length equal to the limit on the number of genes per chromosome that is read in block 104. USED is a logical array that includes an element for each gene and is used to record whether or not a particular operand gene has already been used for a derived function. In block 1010 the entries in USED are initialized to FALSE or an equivalent value (e.g., binary zero).

In block 1012 a variable SERD which stands for Subexpression Root Depth is initialized to MAX_OP_DEPTH-MDEPTH+1. This the highest depth at which a derived function having MDEPTH depth levels can be rooted.

In block 1014 the elite chromosome and the DEPTH array are examined in order to identify all operators at depth SERD. By way of example, with reference to FIG. 5, if MDEPTH were set at three, when block 1014 were executed for the first time a multiplication operator 510 and a square root operator 512 would be identified at depth level three.

Block 1016 will be executed for each of the operators at depth level SERD. In block 1016, for each of the operators at depth level SERD the validating subroutine 700 will be called with the subsequence of the elite chromosome starting from the operator in order to determine the length of the subsequence of genes defining the subexpression rooted in the operator. Then in block 1018, using the DEPTH array a determination is made as to whether the subsequence of genes defining the subexpression rooted at the operator includes at least one gene at depth level SERD+MDEPTH+1 that has not been marked as used in USED array. A positive outcome of block 1018 means that the unused parts of the subexpression rooted in the operator at depth level SERD can be used as the basis for a derived function.

In case of a positive outcome, the subroutine branches to block 1020. In block 1020 the number, DF_OP_CNT of unused operator genes in the subexpression is determined. The number, DF_OP_CNT will be used to adjust L after compression. Next, in block 1022 the structure of the subexpression, excluding any operators already marked as used, and with parameters in place of any arguments, is recorded (e.g. in linear Polish notation). By way of example, with reference to FIG. 5, with MDEPTH equal 3 at SERD=3 a first derived function can be generated based on the subexpression rooted at the square root operator 512. The first derived function would include the square root operator 512, a divide operator 514 which is the child of the square root operator 512 and the minus operator 508. A linear Polish notation representation of the structure of the first derived function is SQRT./. P1.−P2, P3 where P1, P2, P3 are parameters.

Next in block 1024 operator genes in the subexpression, that were previously marked as unused are marked as used in the USED array. Block 1026 which follows represents blocks 824-828 previously described.

If the outcome of block 1018 is negative, and after executing block 1026 the subroutine 1000 proceeds to decision block 1028, the outcome of which depends on whether there are more operators of the operators identified in block 1014 at depth SERD remaining to be processed. If so then in block 1030 subroutine is advanced to the next operator at depth SERD (e.g., by incrementing an index) and thereafter loops back to block 1016 and continues execution.

If on the other hand, it is determined in block 1028 that there are no remaining operators at depth SERD, then the subroutine 1000 branches to block 1032 in which SERD is decremented by 1 to move up one level toward the chromosome root. Next in decision block 1034 SERD is compared to zero to determined if the chromosome root (at depth zero by definition) has been reached. If not then the subroutine 1000 branches to block 1014 in order to determine if derived function(s) can be defined based on subexpressions rooted at the depth value given by the decremented SERD variable. If SERD is found to be equal to zero, the subroutine branches to block 208 in order to process elite chromosomes that have not yet been processed. By comparing SERD to zero in block 1034 a subexpression rooted in the root of the chromosome is ruled out, as the basis for a derived function. Alternatively, subexpressions rooted in the chromosome root are allowed to be the basis of derived functions.

By way of example with reference to FIG. 5, note that the multiplication operator 510 is at the same depth level as the square root operator 512, however if MDEPTH were set to three, a the subexpression rooted in the multiplication operator 510 would be rejected in block 1018 because it only contains a single operator at a single depth level. Moving up one level to depth=2, the plus operator 506 and a multiplication operator 514 are found. At this level, the subexpression rooted at the plus operator 506 includes operators at only two depth levels-insufficient to meet the MDEPTH=3 requirement per the example. In the case of the subexpression rooted at the multiplication operator 514 when the operators that have already been used to define the derived function SQRT./. P1.− are excluded, it is found that the test of block 1018 is not satisfied. Decrementing SERD again brings the subroutine 1000 to depth level 1 at which a single multiplication operator 516 is found. Since the subexpression rooted at the multiplication operator 516 includes the multiplication operator 510 which has not been used and is located at depth level 3, the subexpression rooted at the multiplication operator will give rise to a second derived function represented in linear Polish notation as *.+,P1.*.P2.P3.*.P4.P5 Although the square root operator 512 is also located at depth level 3 because it is already used in the first derived function it will not be included in the second derived function. Table VII shows genes extracted by the subroutine shown in FIG. 10 from the chromsome shown in FIG. 4 if MDEPTH equals three.

TABLE VII

| | | | PARAMETERIZED | | |
|---|---|---|---|---|---|
| | | | LINEAR POLISH | | |
| NAME | TYPE | LIST | REPRESENTATION | FREQ. | INDEX |
| F0 | 5 | *, +, y, *, x, 5, * | *, +, p1, *, p2, p3, *, p4, p5 | 1 | 45 |
| F1 | 4 | sqrt, /, 1, − | sqrt, /, p1, −p2, p3 | 1 | 46 |
| . . . | | . . . | . . . | | |

The second column in Table IV which gives the number of arguments that each derived gene accepts is obtained by running gene sequence in the third column through the validate subroutine 700 and adding the number of operands passed (three in the case of F0, and one in the case of F1) to the final value of rGeneNo (two in the case of F0, and two in the case of F1).

If the alternative shown in FIG. 10 is used, when gene expansion is to be performed in blocks 224 and 306, one or more genes following the index reference to the derived gene in a chromosome are substituted in place of the parameters in the linear polish representation in the fourth column of table VII. In particular, each parameter is replaced by a sequence of genes that is complete in itself, i.e. is a single operand, or codes a complete subexpression. The genes following the index reference to the derived gene are used in order for the first, second, etc parameters. The gene sequence that results from replacing the parameters with the genes taken from the chromosome is then substituted back into the chromosome in place of the index reference to the derived gene. In as much as chromosomes may have multiple derived genes of the type identified by subroutine 1000, an approach to gene expansion that avoids the complexity of replacing the parameters of one derived gene with another derived gene is to start gene expansion at the derived gene closest to the end of the expression encoding portion of the chromosome and work backwards.

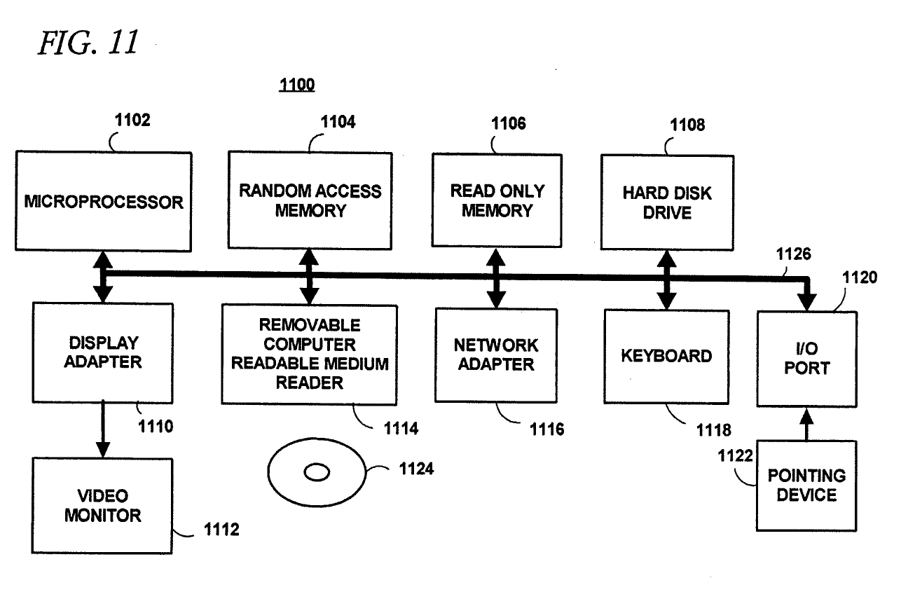

FIG. 11 is a block diagram of a computer 1100 on which the algorithms and routines described above are suitably executed. The computer 1100 includes a microprocessor 1102, Random Access Memory (RAM) 1104, Read Only Memory (ROM) 1106, hard disk drive 1108, display adopter 1110, e.g., a video card, a removable computer readable medium reader 1114, a network adapter 1116, keyboard 1118, and an I/O port 1120 communicatively coupled through a digital signal bus 1126. A video monitor 1112 is electrically coupled to the display adapter 1110 for receiving a video signal. A pointing device 1122, suitably a mouse, is electrically coupled to the I/O port 1120 for receiving electrical signals generated by user operation of the pointing device 1122. According to one embodiment of the invention, the network adapter 1116 is used, to communicatively couple the computer to an external source of data, e.g., a remote server. The computer readable medium reader 1114 suitably includes a Compact Disk (CD) drive. A computer readable medium 1124 that includes software that includes the genetic algorithms and routines described above with reference to FIGS. 1-10 is provided. The software included on the computer readable medium 1124 is loaded through the removable computer readable medium reader 1114 onto the hard disk drive 1108 in order to prepare the computer 1100 to carry out processes of the current invention that are described above with reference to flow diagrams. During execution of the genetic algorithms and routines described above, the algorithms, subroutines and the population of linear Polish chromosomes are suitably stored in the random access memory 1104. The computer 1100 may for example include a personal computer or a work station computer. Alternatively, a network of computers is used to execute the algorithms and subroutines described above.

The genetic algorithms described above can be used for a variety of technical applications including but not limited to symbolic regression, and classification.

The particular arrangement of the blocks in the flowcharts described above was chosen in the interest of pedagogical clarity. It will be apparent to one skilled in the art, that actual programs that, in effect, accomplish what is shown in the flowcharts can vary widely in arrangement depending on the syntax of the programming language in which they are written and the individual programming style of the programmer that writes the actual programs.

A variety of types of computer readably medium including, by way of example, optical, magnetic, or semiconductor memory are alternatively used to store the algorithms, subroutines and chromosomes described above.

While the preferred and other embodiments of the invention have been illustrated and described, it will be clear that the invention is not so limited. Numerous modifications, changes, variations, substitutions, and equivalents will occur to those of ordinary skill in the art without departing from the spirit and scope of the present invention as defined by the following claims.

What is claimed is:

1. A genetic algorithm based method of finding a mathematical expression for a technical problem, the method comprising:
generating an initial population of chromosomes wherein each chromosome encodes a mathematical expression and each chromosome includes operand genes and operator genes;
recursively generating a series of generations of populations of chromosomes from the initial population;
for each population of chromosomes:
selecting an elite group of chromosomes based on fitness to solve the technical problem;
identifying one or more groups of genes in each chromosome in the elite group;
determining a ranking of the groups of genes identified in the elite group according to their frequency in the elite group;
based on the ranking selectively retaining, as one or more derived genes, one or more of the groups of genes;
for each of the one or more derived functions, replacing each particular group of genes by a ID identifying the particular group of genes;
performing one or more evolutionary operations on the population of chromosomes to generate a new population of chromosomes; and
outputting information on a high fitness chromosome.

2. The method according to claim 1 further comprising:
using a high fitness mathematical expression that is encoded in the high fitness chromosome to perform information processing.

3. The method according to claim 1 further comprising,
for each population of chromosomes:
based on the ranking, designating for deactivation one or more derived genes having a relatively low ranking;
for each particular derived gene designated for deactivation and for each chromosome in, at least, the elite group replacing each instance of an ID representing a group of genes which constitute the particular derived gene with the group of genes.

4. The method according to claim 1 wherein:
identifying one or more groups of genes comprises identifying one or more sequences of genes each including a single operator gene and operand genes that are arguments of the single operator gene.

5. The method according to claim 1 further comprising:
evaluating a measure of fitness of each chromosome in each population to solve a symbolic regression problem.

6. The method according to claim 1 further comprising:
evaluating a measure of fitness of each chromosome in each population to solve a classification problem.

7. The method according to claim 1 wherein:
identifying one or more groups of genes comprises:
determining a depth of each operator gene in a tree expression representation of each mathematical expression
determining a maximum depth of any operator in each mathematical expression;
reading a first parameter which determines a number of depth levels to be spanned by each of the one or more groups of genes;
for each K^{th} depth level among a plurality of depth levels identifying a plurality of operators at the K^{th} depth level;
for each jth operator among one or more of the plurality of operators at the K^{th} depth level, identifying a subexpression rooted by the jth operator and determining if the subexpression includes operators at the number of depth levels; and
if the subexpression includes operators at the number of depth levels, selecting one of the one or more groups of genes from the subexpression.

8. The method according to claim 7 wherein particular genes are not used in more than one of the groups of genes.

9. The method according to claim 8 wherein groups of genes are first identified in one or more subexpressions rooted at a N^{th} level and subsequently identified in subexpressions rooted at successively lower depth levels.

10. The method according to claim 1 wherein:
identifying one or more groups genes comprises identifying one or more groups of genes, each including two or more operators.

11. The method according to claim 10 wherein the two or more operators encode a part of a mathematical expression in which an output of one of the two or more operators contributes to input of another of the two or more operators.

12. The method according to claim 10 wherein said one or more groups of genes do not include operand genes.

13. A computer readable medium storing a plurality of data structures that serve as population members in a genetic algorithm, wherein each of said data structures comprises:
an array including a plurality of indexes, wherein each index represents genetic programming gene selected from the group consisting of operands and operators, and wherein said plurality of indexes encode expression trees in Polish notation.

14. A computer readable medium storing a genetic algorithm based method of finding a mathematical expression for a technical problem, the computer readable medium including instructions for:
generating an initial population of chromosomes wherein each chromosome encodes a mathematical expression and each chromosome includes operand genes and operator genes;
recursively generating a series of generations of populations of chromosomes from the initial population;
for each population of chromosomes:
selecting an elite group of chromosomes based on fitness to solve the technical problem;
identifying one or more groups of genes in each chromosome in the elite group;
determining a ranking of the groups of genes identified in the elite group according to their frequency in the elite group;
based on the ranking selectively retaining, as one or more derived genes, one or more of the groups of genes;
for each of the one or more derived functions, replacing each particular group of genes by a ID identifying the particular group of genes; and
performing one or more evolutionary operations on the population of chromosomes to generate a new population of chromosomes; and
outputting information on a high fitness chromosome.

15. The computer readable medium according to claim 14 further comprising programming instructions for:
using a high fitness mathematical expression that is encoded in the high fitness chromosome to perform information processing.

16. The computer readable medium according to claim 14 further comprising programming instructions for:
for each population of chromosomes:
based on the ranking, designating for deactivation one or more derived genes having a relatively low ranking;
for each particular derived gene designated for deactivation and for each chromosome in, at least, the elite group replacing each instance of an ID representing a group of genes which constitute the particular derived gene with the group of genes.

17. The computer readable medium according to claim 14 wherein:
the programming instructions for identifying one or more groups of genes comprise programming instructions for identifying one or more sequences of genes each including a single operator gene and operand genes that are arguments of the single operator gene.

18. The computer readable medium according to claim 14 further comprising programming instructions for:
evaluating a measure of fitness of each chromosome in each population to solve a symbolic regression problem.

19. The computer readable medium according to claim 14 further comprising programming instructions for:
evaluating a measure of fitness of each chromosome in each population to solve a classification problem.

20. The computer readable medium according to claim 14 wherein said programming instructions for:
identifying one or more groups of genes comprise programming instructions for:
determining a depth of each operator gene in a tree expression representation of each mathematical expression
determining a maximum depth of any operator in each mathematical expression;
reading a first parameter which determines a number of depth levels to be spanned by each of the one or more groups of genes;
for each K^{th} depth level among a plurality of depth levels identifying a plurality of operators at the K^{th} depth level;
for each j^{th} operator among one or more of the plurality of operators at the K^{th} depth level, identifying a subexpression rooted by the jth operator and determining if the subexpression includes operators at the number of depth levels; and
if the subexpression includes operators at the number of depth levels, selecting one of the one or more groups of genes from the subexpression.

21. The computer readable medium according to claim 20 wherein the programming instructions do not use particular genes in more than one of the groups of genes.

22. The computer readable medium according to claim 21 comprising programming instructions for:
first identifying groups of genes in one or more subexpressions rooted at a N^{th} level and subsequently identifying groups of genes in subexpressions rooted at successively lower depth levels.

23. The computer readable medium according to claim 14 wherein:
the programming instructions for identifying one or more groups genes comprise programming instructions for identifying one or more groups of genes, each including two or more operators.

24. The computer readable medium according to claim 23 wherein the programming instructions for identifying one or more groups of genes each including two or more operators comprise programming instructions for identifying one or more groups of genes in which an output of one of the two or more operators contributes to input of another of the two or more operators.

25. The computer readable medium according to claim 23 wherein the programming instructions for identifying one or more groups of genes include programming instructions for identifying one or more groups of genes that do not include operand genes.

26. A genetic algorithm system comprising:
a means for generating an initial population of chromosomes wherein each chromosome encodes a mathematical expression and each chromosome includes operand genes and operator genes;
a means for recursively generating a series of generations of populations of chromosomes from the initial population;
a means for selecting an elite group of chromosomes based on fitness to solve the technical problem from each population of chromosomes;
a means for identifying one or more groups of genes in each chromosome in the elite group;
a means for determining a ranking of the groups of genes identified in the elite group according to their frequency in the elite group;
a means for selectively retaining, as one or more derived genes, one or more of the groups of genes based on the ranking;
a means for replacing each particular group of genes by a ID identifying the particular group of genes; and
a means for performing one or more evolutionary operations on the population of chromosomes to generate a new population of chromosomes;
a means for outputting information on a high fitness chromosome.

27. The system according to claim 27 further comprising:
a means for using a high fitness mathematical expression that is encoded in the high fitness chromosome to perform information processing.
